(19) United States
(12) Patent Application Publication
(10) Pub. No.: US 2023/0033418 A1
(43) Pub. Date: Feb. 2, 2023

(54) A PROCESS FOR MANUFACTURING CINNAMON TEA POD FROM CINNAMOMUM ZEYLANICUM

(71) Applicant: Sabaragamuwa University of Sri Lanka, Belihuloya (LK)

(72) Inventors: Devarahandhi Achini Melda De Sliva, Ahungalla (LK); Chathurika Jeewanthi Renda Kankanamge, Balangoda (LK); Mudiyanselage Tharaka Bilindu Weddagala, Kandy (LK); Karunarathna Basnayaka Subasinhage Sri Janaranjana Ekanayaka, Jambugahapitiya (LK)

(21) Appl. No.: 17/786,719

(22) PCT Filed: Dec. 18, 2020
(86) PCT No.: PCT/IB2020/062174

§ 371 Date: Jun. 17, 2022

(30) Foreign Application Priority Data
Dec. 20, 2019 (LK) LK/P/20905

(51) Int. Cl. A23F 3/34; A23F 3/14; A23F 3/26

(52) U.S. Cl. CPC A23F 3/34; A23F 3/14; A23F 3/26

(57) ABSTRACT

The present invention discloses a process for manufacturing cinnamon tea pod. The process involves pre-treating Ceylon zeylanicum leaves by blanching the leaves for a predefined time set to enable a cessation of enzymatic activity in the cinnamon leaves. The process further involves dehydrating the Cinnamon (Ceylon zeylanicum) leaves at a preset dehydrating conditions to prepare cinnamon leaves particles. The process is followed by preparing cinnamon bark extract powder under predefined conditions. The process is continued by mixing the Ceylon zeylanicum particles and the cinnamon bark extract powder in a ratio of 98 wt. % to 2 wt. % respectively. At last, the process involves preparing tea pods including the mixed cinnamon leaves particles with the said cinnamon bark extract.

This application claims benefit of complete application number LK/P/20905 filed on 20 Dec. 2019.

### FIELD OF THE INVENTION

The present invention relates to a field of development of a natural health (herbal) beverage product. More particularly, to a process for manufacturing tea pod from cinnamon, and specifically a process for manufacturing tea pod from Ceylon cinnamon leaves and cinnamon bark extract.

### BACKGROUND OF THE INVENTION

In recent times, working clan usually forgets to take care of themselves, due to busy life and work pressures. People are unable to exercise regularly, and do not follow a healthy diet. In addition, pollutants in environment worsen the scenario.

Pollutants not only makes respiratory system and cardiac system disease progression, but also may affect fecundity.

Various studies have found that drinking water-based products may help in discharging toxin from the human body. One such water-based product is tea, and studies have found that tea has many health-care functions.

More specifically, tea made from Cinnamon naturally contains low calories and regulates blood sugar levels. Additionally, the cinnamon tea has various benefits in controlling diabetes, losing weight, preventing and treating decayed teeth, bodily temperature control, reducing pathogenic fire, resisting smoke, and sobering up the body, and other similar benefits.

From the ancient world to the present world, Cinnamon is a luxury spice that has been consumed for its medicinal properties and health benefits.

Cinnamon is usually used in manufacturing of food (confectionary and bakery), medicinal (pharmaceutical and nutraceutical) and cosmetic industry, due to its various anti-fungal, antiviral, anticarcinogenic and antibacterial properties.

However, the use of Cinnamon in preparing beverages is still limited.

One such invention, which uses Cinnamon to produce a beverage is disclosed in Korean patent application with publication number 20010096327.

The application discloses a process for preparing a black nightshade drink by mixing natural black nightshade as a main material with a Cinnamon extract, a Glycyrrhizae radix extract, fructooligosaccharide or the like. The drink made form the said process is having anticancer and anti-inflammatory actions.

However, the drink includes many other ingredients apart from Cinnamon extract. Therefore, a process for manufacturing tea pods is required which uses only Cinnamon based ingredients.

One more invention which uses Cinnamon is disclosed in WIPO patent publication number 2018142419.

The invention discloses a cardiac and anti-lipidimic beverage. The said beverage consists of a mixture of water and milk, to which an extract of mixture of herbs is added. The said extract being prepared from a mixture of herbs consisting of specific herbs (such as Cinnamon, Rosa centifolia Petals etc.) combined in optimal quantities.

However, the beverage product is carbonated food product, and uses various ingredients other than Cinnamon. Further, the mixture of the herbs being extracted using alcohol.

In recent times, the most commonly consumed type of the Cinnamon is Cinnamomum cassia. Other varieties are C. burmannii (Korintje, Padang cassia, or Indonesian cinnamon), C. loureiroi (Saigon cinnamon, Vietnamese cassia, or Vietnamese cinnamon) and C. citriodorum (Malabar cinnamon).

However, the said varieties of Cinnamon has high coumarin content. Coumarin is a known toxic compound. Therefore, there is need of the Cinnamon which has no, or very less amount of the coumarin content.

One particular type of Cinnamon, found in Sri Lanka, which is also considered as true Cinnamon, is called as Cinnamomum zeylanicum.

However, currently Sri Lanka has been unable to develop exporting value created products rather than limited number of products using true Cinnamon.

Specifically, the beverage industry needs to be developed in Sri Lanka. The tea industry is been dominated by tea from Camellia sinensis for prolonged time. The global market is seeking new flavors, functional benefits, and user-friendly applications.

Therefore, there is a gap to fill in the market in value creation process and gain the largest profit share from the said true Cinnamon.

Therefore, there is need to develop a process which may use only Cinnamon based ingredients, and should not use alcohol for the extraction of the said Cinnamon.

Generally, the existing extraction processes of the Cinnamon use spray drying techniques, long time heating, and evaporation methods which lead to destroy the heat sensitive properties in the Cinnamon.

Therefore, the processing of the Cinnamon should be done in such a manner that the processing may not destroy the healthy chemical and sensitive properties of the said Cinnamon.

Also, in cinnamon industry, Cinnamon leaves have not been used yet for direct food/beverage applications owing to its strong taste and slimy property development after cell structure breakage in crushing or grinding. Further, there were lots of experiments that have been done with natural chemical application and physical barrier applications to bring the leaves to edible form but discarded in the field as a non-usable item.

In addition, in the existing processes from the field of manufacturing tea, the tea is not produced from the Cinnamon leaves till now.

Therefore, there is need to develop a process of manufacturing tea from the Cinnamon leaves.

Further, a process for manufacturing tea pods from Cinnamon is required, in which tea may possess maximum functional benefits (without adulteration).

Furthermore, a process for manufacturing Cinnamon tea pods is required which may be consumed frequently and provide benefits without destroying the healthy chemical properties in the manufacturing process.

In nutshell, a process for manufacturing Cinnamon tea pods is required which may overcomes above discussed drawbacks.

### SUMMARY OF THE INVENTION

In an aspect of the present invention, a process for manufacturing cinnamon tea pod is disclosed.

The process for manufacturing cinnamon tea pod includes pre-treating cinnamon leaves by blanching the said leaves for a predefined time set to enable a cessation of enzymatic activity in the said cinnamon leaves.

In an embodiment of the present invention, the blanching of the said leaves is carried out for a time period of about 20 seconds for cessation of the said enzymatic activity in the leaves and enabling a balance of flavor profiles.

Further, the process involves dehydrating the said cinnamon leaves at a preset dehydrating conditions to prepare cinnamon leaves particles.

In various embodiments, the dehydration of the said blanched leaves is carried out at a temperature of about 45° C. for 5 hours to remove moisture from the said leaves. Accordingly, grinding the said leaves into particles within a predefined size range.

The process further includes preparing cinnamon bark extract powder under predefined conditions.

In one embodiment of the present invention, the preparation the said cinnamon bark extract powder includes grinding cinnamon bark in a cool jacketed spice grinder at about 1000 rpm while maintaining temperature levels at a desired level.

The said grinding is done with 2-3 min intervals. Further, the bark powder is agitated in distilled water continuously at a temperature of about 4° C. for about 24 hours in a sealed container.

The process further includes filtering the said powder with a set of filters including three separate filters, and freeze drying the said filtrate product by maintaining temperature in a range of about (−) 50° C. to about (−) 18° C. and pressure in a range of 20-30 Pa for about 24-36 hours. The said cinnamon bark extract powder is concentrated 100:1 by water extract.

In the said embodiment of the present invention, the said cinnamon bark extract powder is stored in sterilized tubes or bottles at a temperature of −18° C. to protect the volatile compounds and heat sensitive properties of cinnamon.

Further, the process for manufacturing cinnamon tea pod involves mixing the said cinnamon leaves particles with the said cinnamon bark extract powder in a predefined ratio.

Specifically, the process involves mixing the Ceylon zeylanicum particles and the cinnamon bark extract powder in a ratio of 98 wt. % to 2 wt. % respectively.

At last, the process includes preparing tea pods including the mixed cinnamon leaves powder with the said cinnamon bark extract.

This together with the other aspects of the present invention along with the various features of novelty that characterized the present disclosure is pointed out with particularity in claims annexed hereto and forms a part of the present invention.

For better understanding of the present disclosure, its operating advantages, and the specified objective attained by its uses, reference should be made to the accompanying descriptive matter in which there are illustrated exemplary embodiments of the present invention.

### DESCRIPTION OF THE DRAWINGS

The advantages and features of the present invention will become better understood with reference to the following detailed description taken in conjunction with the accompanying drawings, in which:

FIG. 1 illustrates a flow chart depicting an exemplary process for manufacturing cinnamon tea pod, according to various embodiments of the present invention;

FIG. 2 illustrates a flow chart depicting sub-steps including in dehydration of cinnamon leaves to prepare cinnamon leaves particles, according to various embodiments of the present invention; and

FIG. 3 illustrates a flow chart depicting sub-steps including in preparation of cinnamon bark extract powder, according to various embodiments of the present invention.

Like numerals denote like elements throughout the figures.

### DESCRIPTION OF THE INVENTION

The exemplary embodiments described herein detail for illustrative purposes are subjected to many variations. It should be emphasized, however, that the present invention is not limited to as disclosed. It is understood that various omissions and substitutions of equivalents are contemplated as circumstances may suggest or render expedient, but these are intended to cover the application or implementation without departing from the spirit or scope of the present invention.

Specifically, the following terms have the meanings indicated below.

The terms “a” and “an” herein do not denote a limitation of quantity, but rather denote the presence of at least one of the referenced items.

The terms “having”, “comprising”, “including”, and variations thereof signify the presence of a component.

The present invention discloses a process for manufacturing cinnamon tea pod.

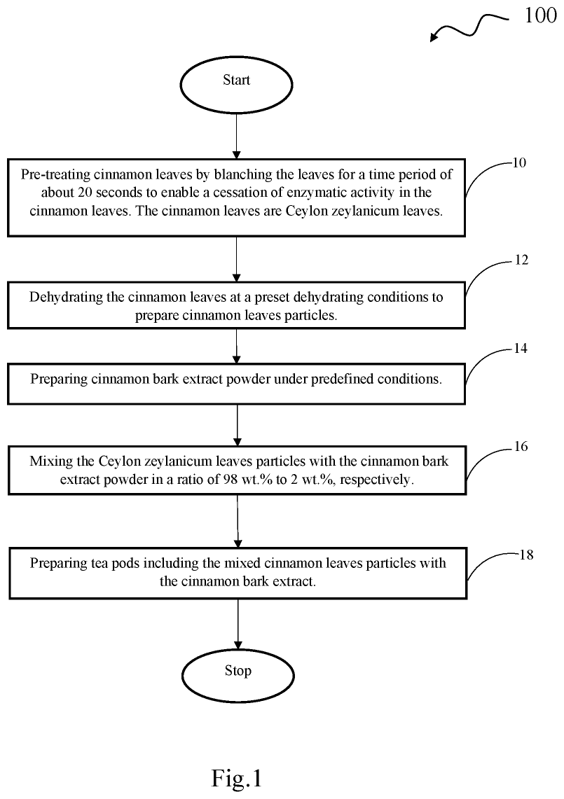

The inventive aspects of the invention along with various components and engineering involved will now be explained with reference to FIGS. 1-3 herein.

Referring to FIG. 1, at step (10), the process (100) of manufacturing tea pods includes pre-treating cinnamon leaves for a predefined time.

The pre-treating enables cessation of enzymatic activity in the said cinnamon leaves.

In various embodiments of the present invention, the said cinnamon leaves are Ceylon zeylanicum leaves also called as true cinnamon, commonly available in Sri Lanka.

It has been proved by various experimental findings that said Ceylon Cinnamon (Sri Lanka cinnamon, Ceylon cinnamon or Cinnamomum zeylanicum) is free from toxic compound called coumarin that is toxic to the human liver.

Therefore, such Cinnamon has various health benefits which have been exploited in the present invention.

Coming back to the process, the said Cinnamon leaves were picked after analysing different graded cinnamon samples. The said Ceylon zeylanicum (Cinnamomum zeylanicum) leaves of the Sri Lanka have high nutritional composition and functional activities.

Further, as mentioned above, the said leaves selected for the process (100) of the present invention, are having no, or trace amounts of coumarin content that is highly toxic to the human liver.

Again, coming back to step (10), the pre-treating of the said Ceylon zeylanicum leaves includes specifically blanching the said leaves for a period of about 20 seconds for cessation of the said enzymatic activity in the said leaves.

The said blanching also enables a balance of the flavor profiles in the said leaves. Without, the said blanching process the said leaves give slimy effect and strong after palette taste to a tea.

Further, the process (100) at step (12), involves dehydrating the immature Cinnamon leaves at a preset dehydrating conditions to prepare Cinnamon leaves particles. The said leaves are dehydrated (within 3 or 4 hours) after the blanching process.

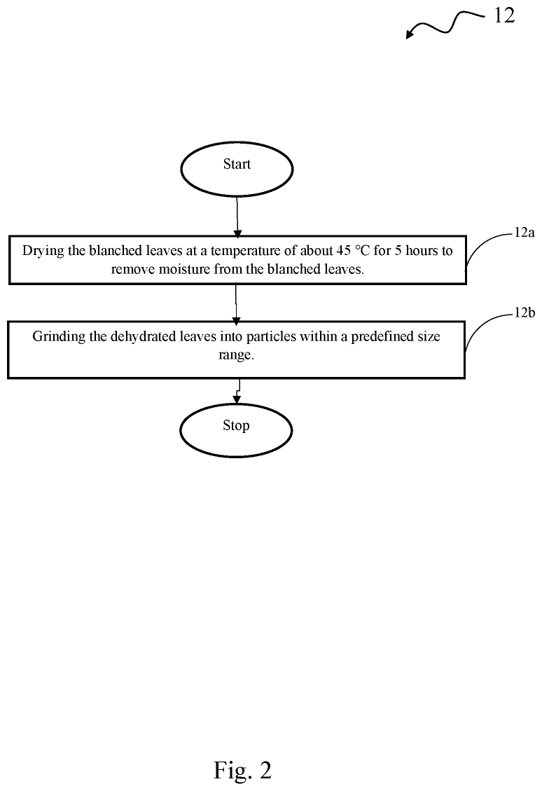

In an embodiment of the present invention, the said dehydration process of the leaves enhances the taste without harming the colour or nutritional properties of Ceylon cinnamon leaves. The said dehydration of the said blanched leaves includes sub-steps (12a) and (12b) (refer FIG. 2).

In the embodiment of the present invention, referring to FIG. 2, at sub-step (12a), the process (100) involves drying the said blanched leaves at a temperature of about 45° C. for 5 hours to remove moisture from the said leaves.

In the said embodiment of the present invention, a careful selection (sorting) is needed in the said sub-step (12a), since some leaves may not sufficiently matured. Therefore, dark colour leaves should be removed to maintain the flavour profile and chemical properties in the said leaves.

Again, referring to FIG. 2, further, at sub-step (12b), the process (100) involves grinding the said leaves into particles (fine particles) within a predefined size range, or the grinding the said leaves into powder form.

Coming back to FIG. 1, the process (100) continues with step (14), by preparing Cinnamon bark extract powder under predefined conditions.

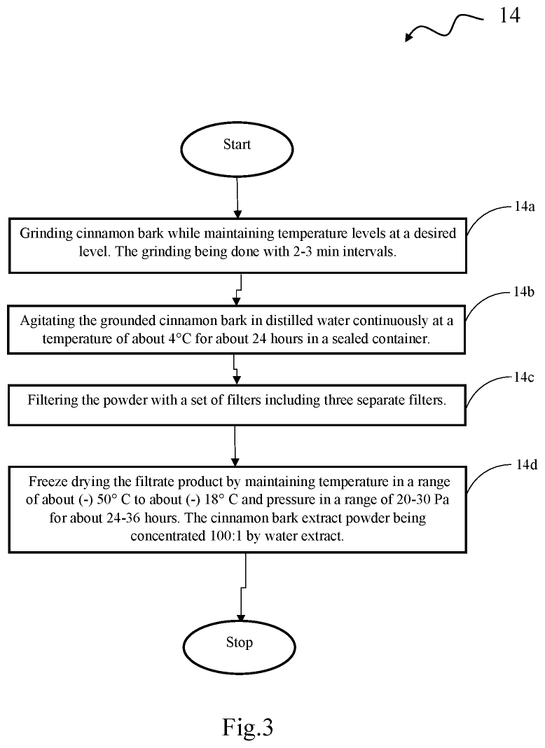

In the embodiment of the present invention, the preparation of the said cinnamon bark extract powder includes sub-steps (14a), (14b), (14c), and (14d) (refer FIG. 3).

Referring to FIG. 3, at sub-step (14a), the process (100) involves grinding cinnamon bark while maintaining temperature levels at a desired level. The grinding is done in a cool jacketed spice grinder at about 1000 rpm with 2-3 min intervals. However, it should be understood that other grinding techniques may also be used to facilitate the step (14a).

Further at sub-step (14b), the process (100) includes agitating the said grounded cinnamon bark in distilled water continuously at a temperature of about 4° C. for about 12-24 hours in a sealed container (refer FIG. 3).

The said powder at step (14c) is then filtered with a set of filters including three separate filters. The filtration carried out is pressure filtration so that excess raw water pressure is not lost when the filtration process takes place.

Again, referring to FIG. 3, at sub-step (14d), the process (100) involves freeze drying the said filtrate product by maintaining temperature in a range of about (−) 50° C. to about (−) 18° C. and pressure in a range of 20-30 Pa for about 24-36 hours.

The said cinnamon bark extract powder so obtained is then concentrated 100:1 by water extract.

In the said embodiment of the present invention, the said cinnamon bark extract powder is stored in sterilized tubes or bottles at a temperature of about (−) 18° C. to protect the volatile compounds and heat sensitive properties of the Cinnamon.

Since Cinnamon extract preparation is done without using heat sources, the antioxidant compounds and volatile compounds like heat sensitive components are being preserved in the product which claims the health benefits.

Again, coming back to FIG. 1, at step (16), the process (100) involves mixing the said cinnamon leaves particles with the said cinnamon bark extract powder in a predefined ratio.

Specifically, in a preferred embodiment, the mixing the Ceylon zeylanicum particles and the Cinnamon bark extract powder in a ratio of 98 wt. % to 2 wt. % respectively.

At last at step (18), the process involves preparing tea pods including the mixed cinnamon leaves powder with the said cinnamon bark extract (refer FIG. 1). Such tea pods may be packed in a cardboard box with 6 or 18 capsules each, or otherwise according to needs and desire of the customer.

In the embodiment of the present invention, the said tea pod is provided in form of at least one of a thimble, or a capsule of about 25 ml volume.

The said capsule is being sealed with a removable aluminium cover, and stored at a temperature of about 2° C. Accordingly, the tea pods are packed in cardboard boxes with 6 or 18 capsules in each cardboard box.

The tea made by the tea pods (capsule/thimble) of the present invention is not only keeping the health benefits but also keeping the characteristics of natural cinnamon aroma and taste of cinnamon which has refreshed taste with a unique flavour.

The Cinnamon tea as provided by this invention is not only keeping the health benefits, but also keeping the characteristics of natural Cinnamon aroma and taste of Cinnamon which has refreshed taste with a unique flavor; due to adoption of a low-temperature and vacuum freeze drying mode, effective.

Further, the capsule is a novel approach for health beverage tea sector in Sri Lanka. The tea capsule gives a higher commercial value to the product and best suits with the export market.

Furthermore, the Ceylon cinnamon (Sri Lanka cinnamon, Ceylon cinnamon or Cinnamomum zeylanicum) used in the present invention is free from toxic compound called coumarin, when compared to the other foreign cinnamon types in the world market such as Cinnamomum cassia (cassia or Chinese cinnamon, the most common commercial type) C. burmannii (Korintje, Padang cassia, or Indonesian cinnamon) C. loureiroi (Saigon cinnamon, Vietnamese cassia, or Vietnamese cinnamon) and C. citriodorum (Malabar cinnamon).

In addition, not like other species that have prominent different chemical composition and morphological characters with each other, the Ceylon Cinnamon has been reported for only providing the health benefits for the human mainly for diabetes, hormonal imbalance, obesity etc.

Further, the process for manufacturing of the Cinnamon tea pods in the present invention does not need any adulteration, and Cinnamon extract is prepared using mild or lower temperatures. Also, the production steps were done under laboratory aseptic conditions.

Specifically, the process of the present invention uses only Ceylon Cinnamon (Cinnamomum zeylanicum) for manufacturing tea pods. Therefore, no artificial flavours, colours or preservatives have been used in the manufacturing the tea pods of the present invention.

Furthermore, a sensory quality of the cinnamon tea made from the tea pod of the present invention is approved by a sensory test with 100 people, and is claimed as a refreshed tea for consumption.

Additionally, a taste and aroma of the tea made from the tea pod of the present invention is unique. Also, the consumer's satisfaction level is higher s it gives calm environment with a refreshment to the consumer.

In nutshell, the process for manufacturing the Cinnamon tea pods overcomes above discussed drawbacks.

The foregoing descriptions of specific embodiments of the present invention have been presented for purposes of description. They are not intended to be exhaustive or to limit the present invention to the precise forms disclosed, and obviously many modifications and variations are possible in light of the above teaching.

Further, the embodiments were chosen and described in order to best explain the principles of the present invention and its practical application, and thereby enable others skilled in the art to best utilize the present invention and various embodiments with various modifications as are suited to the particular use contemplated.

It is understood that various omissions and substitutions of equivalents are contemplated as circumstances may suggest or render expedient, but such omissions and substitutions are intended to cover the application or implementation without departing from the spirit or scope of the present invention.

1. A process (100) for manufacturing cinnamon tea pod, the process comprising:
pre-treating cinnamon leaves by blanching the said leaves for a predefined time set to enable a cessation of enzymatic activity in the said cinnamon leaves;
dehydrating the said cinnamon leaves at a preset dehydrating conditions to prepare cinnamon leaves particles;
preparing cinnamon bark extract powder under predefined conditions;
mixing the said cinnamon leaves particles with the said cinnamon bark extract powder in a predefined ratio; and
preparing tea pods comprising the mixed cinnamon leaves particles with the said cinnamon bark extract,
wherein the said cinnamon leaves comprises Ceylon zeylanicum leaves, and wherein the mixing of the said leaves particles with the said bark extract powder comprises mixing the Ceylon zeylanicum particles and the cinnamon bark extract powder in a ratio of 98 wt. % to 2 wt. % respectively.

2. The process (100) as claimed in claim 1, wherein the said pre-treating of the cinnamon leaves comprises blanching the said leaves for a period of about 20 seconds for cessation of the said enzymatic activity in the leaves and enabling a balance of flavor profiles.

3. The process (100) as claimed in claim 1, wherein the dehydration of the said cinnamon leaves to prepare leaves particles comprises,
drying the said blanched leaves at a temperature of about 45° C. for 5 hours to remove moisture from the said leaves, and
grinding the said leaves into particles within a predefined size range.

4. The process (100) as claimed in claim 1, wherein the preparation of the said cinnamon bark extract powder comprises,
grinding cinnamon bark while maintaining temperature levels at a desired level, the said grinding being done with 2-3 min intervals,
agitating the said grounded cinnamon bark in distilled water continuously at a temperature of about 4° C. for about 24 hours in a sealed container,
filtering the said powder with a set of filters comprising three separate filters, and
freeze drying the said filtrate product by maintaining temperature in a range of about (−) 50° C. to about (−) 18° C. and pressure in a range of 20-30 Pa for about 24-36 hours, wherein
the said cinnamon bark extract powder being concentrated 100:1 by water extract.

5. The process (100) as claimed in claim 4, wherein the grinding is done in a cool jacketed spice grinder at about 1000 rpm.

6. The process (100) as claimed in claim 4, wherein the said process comprises storing the said cinnamon bark extract powder in sterilized tubes or bottles at a temperature of −18° C. for protecting the volatile compounds and heat sensitive properties of cinnamon.

7. The process (100) as claimed in claim 1, wherein the said cinnamon tea pod is at least one of a thimble, or a capsule of about 25 ml volume, the said capsule being sealed with a removable aluminum cover.
